(19) United States
(12) Patent Application Publication
(10) Pub. No.: US 2018/0204083 A1
(43) Pub. Date: Jul. 19, 2018

(54) COGNITIVE OBJECT AND OBJECT USE RECOGNITION USING DIGITAL IMAGES

(71) Applicant: INTERNATIONAL BUSINESS MACHINES CORPORATION, Armonk, NY (US)

(72) Inventors: Munish GOYAL, Yorktown Heights, NY (US); Wing L. LEUNG, Austin, TX (US); Sarbajit K. RAKSHIT, Kolkata (IN); Kimberly G. STARKS, Nashville, TN (US)

(21) Appl. No.: 15/407,718

(22) Filed: Jan. 17, 2017

(51) Int. Cl. G06K 9/46; G06K 9/62; G06F 17/30

(52) U.S. Cl. CPC G06K 9/4604; G06F 17/30595; G06F 17/30259; G06K 9/6201

(57) ABSTRACT

Systems and methods for cognitive object and object use recognition using digital images are disclosed. In embodiments, a computer-implemented method comprises: receiving, by a computing device, a plurality of digital images; extracting, by the computing device, image objects depicted in the plurality of digital images and metadata associated with the plurality of digital images; performing, by the computing device, contextual analysis of each of the image objects; and generating, by the computing device, relationship data based on the contextual analysis including a relationship between each of the image objects and one or more usages of the image object.

### BACKGROUND

The present invention relates generally to digital image analysis and, more particularly, to cognitive object and object use recognition using digital images.

Limitations exist regarding a person's ability to recognize certain objects in digital images. This may be problematic when a person is performing an image or video analysis or when a person is trying to understand how an object is being utilized. Given any event, a plurality of images can be captured from different directions at different time periods. One image can contain multiple human and non-human objects. The role of a particular object may vary based on context. Some objects can be used for different purposes in different contexts. A person evaluating an image may not be able to recognize one or more objects and relationships of the object with any other object. Therefore, it would be desirable to be able to automatically identify relationships of objects with other associated objects and recognize the objects based on their usage or other available context information.

### SUMMARY

In an aspect of the invention, a computer-implemented method for cognitive object and object use recognition using digital images includes: receiving, by a computing device, a plurality of digital images; extracting, by the computing device, image objects depicted in the plurality of digital images and metadata associated with the plurality of digital images; performing, by the computing device, contextual analysis of each of the image objects; and generating, by the computing device, relationship data based on the contextual analysis including a relationship between each of the image objects and one or more usages of the image object.

In another aspect of the invention, there is a computer program product for cognitive object and object use recognition using digital images. The computer program product comprises a computer readable storage medium having program instructions embodied therewith. The program instructions are executable by a computing device to cause the computing device to: receive a plurality of digital images and context data associated with the plurality of digital images; extract image objects depicted in the plurality of digital images and metadata associated with the plurality of digital images; perform contextual analysis of each of the image objects and the context data; and generate relationship data based on the contextual analysis including a relationship between each of the image objects and one or more usages of the image object.

In another aspect of the invention, there is a system for cognitive object and object use recognition using digital images. The system includes a CPU, a computer readable memory and a computer readable storage medium associated with a computing device; program instructions to receive a plurality of digital images and context data associated with the plurality of digital images; program instructions to extract image objects depicted in the plurality of digital images associated with the plurality of digital images; program instructions to perform contextual analysis of each of the image objects and the context data; program instructions to generate relationship data based on the contextual analysis, including a relationship between each of the image objects and one or more usages of the image object; program instructions to receive a user query; program instructions to identify one or more objects of the user query and one or more uses of the object; and program instructions to generate a response to the query based on the identifying, wherein the program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computing infrastructure according to an embodiment of the present invention.

FIG. 2 shows an exemplary environment in accordance with aspects of the invention.

FIG. 3 shows a flowchart of steps of a method in accordance with aspects of the invention.

FIG. 4 shows a digital image analyzed in accordance with embodiments of the invention.

### DETAILED DESCRIPTION

The present invention relates generally to digital image analysis and, more particularly, to cognitive object and object use recognition using digital images. In embodiments, a system and method are provided for analyzing digital images (e.g., photographs and video images) to identify relationships of an object within the image with other associated objects, analyze actions being performed in the image, and recognize the object based on its usage. In aspects, context data surrounding or associated with an image (e.g., spoken content, sensor data, biometric information, environmental parameters, etc.) is utilized to automatically recognize various objects based on their role, action and usage. By way of example, a system of the invention may detect that a user in an image is applying pressure on an object in the image, and may detect that associated smartwatch device data indicates that the user is losing calories. In this scenario, the system may identify that the object is a hand exercise machine based on the surrounding context data (smartwatch data).

In embodiments, the invention addresses the technical problem of object and object use recognition utilizing contextual analysis of digital images to create an image database of information that can be utilized to provide object information to users. In aspects, the invention provides information to a user regarding an object seen in a digital image using the cumulative knowledge gathered from sound data, sensor data, metadata, and text data associated with previously analyzed digital images. In this way, a user may be provided with information regarding the object in the digital image that may not be readily apparent to the user when viewing the digital image.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

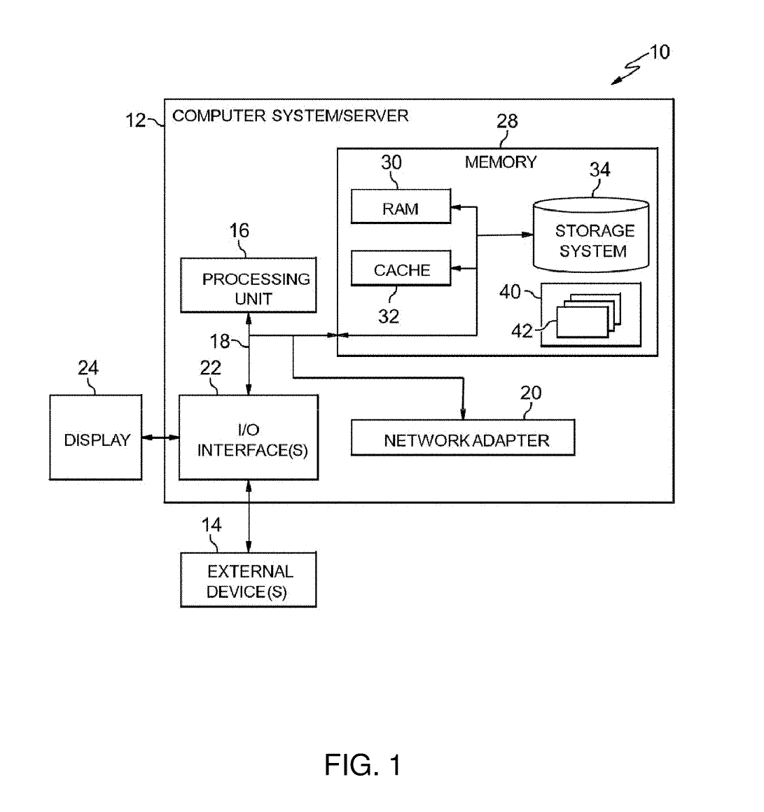

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

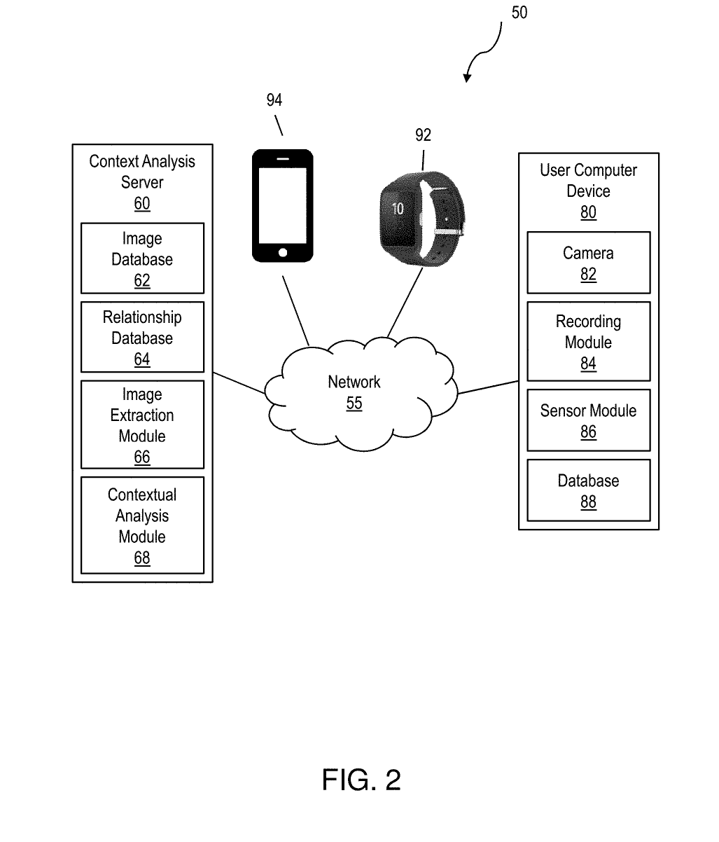

FIG. 2 shows an exemplary cognitive object and object use recognition system 50 and environment in accordance with aspects of the invention. The environment includes a context analysis server 60 connected to a network 55. The context analysis server 60 may comprise a computer system 12 of FIG. 1, and may be connected to the network 55 via the network adapter 20 of FIG. 1. The context analysis server 60 may be configured as a special purpose computing device that is part of a service provider's infrastructure. For example, the context analysis server 60 may be configured to receive image data, context data associated with the image data, and image queries from a user computer device 80 through the network 55. The context analysis server 60 may also be configured to receive image data and/or context data associated with the image from a variety of other sources, such as a smartwatch 92 and a mobile device 94, through the network 55.

The network 55 may be any suitable communication network or combination of networks, such as a local area network (LAN), a general wide area network (WAN), and/or a public network (e.g., the Internet). The user computer device 80 may be a general purpose computing device, such as a desktop computer, laptop computer, tablet computer, smartphone, etc. In embodiments, the user computer device 80 runs a program by which a user may communicate with the context analysis server 60. In aspects, the user computer device 80 includes a camera 82 for capturing digital images (e.g., photographs or videos), a recording module 84 for recording sounds associated with the digital images, a sensor module 86 for capturing context data associated with the digital images, and a database 88 for storing captured data. The context analysis server 60 may be configured to communicate with plural different user computer devices simultaneously, and provide context analysis services to each of the user computer devices independent of the others.

Still referring to FIG. 2, in embodiments, the context analysis server 60 includes an image database 62 for storing digital image data and context data, and a relationship database 64 for storing relationship data generated by the context analysis server 60. In embodiments, an image extraction module 66 and a contextual analysis module 68 are configured to perform one or more of the functions described herein. The image extraction module 66 and the contextual analysis module 68 may include one or more program modules (e.g., program module 42 of FIG. 1) executed by the context analysis server 60. In embodiments, the image extraction module 66 is configured to extract image objects (objects depicted within the digital image at issue) and metadata from the image data stored in the image database 62. In aspects, the contextual analysis module 68 is configured to perform contextual analysis of each identified image object using context data and historic relationship data stored in the relationship database 64, and generate relationship data for each image object.

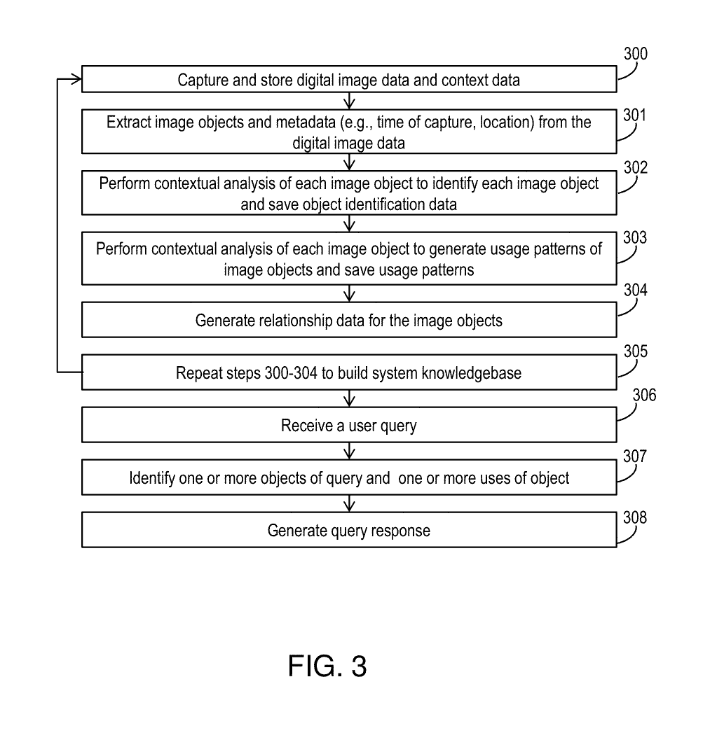

FIG. 3 shows a flowchart of a method in accordance with aspects of the invention. Steps of the method of FIG. 3 may be performed in the environment illustrated in FIG. 2, and are described with reference to elements shown in FIG. 2.

At step 300, digital image data is captured and stored, along with context data. In embodiments, the user computer device 80 captures the digital image data utilizing the camera 82. In embodiments, the user computer device 80 also captures context data associated with the captured digital image data, such as sensor data from the sensor module 86 and sound data from the recording module 84. In embodiments, the digital image data and/or the context data is captured by an additional device, such as the mobile device 94 and the smartwatch 92. In embodiments, the context analysis server 60 obtains the digital image and context data from the user computer device 80 and/or one or more other devices such as the mobile device 94 and the smartwatch 92, and saves the data in the image database 62. In embodiments, the context analysis server 60 provides its own digital image and context data, such as through a camera, recording device, sensors, etc. (not shown).

At step 301, image objects and metadata are extracted from the digital image data. In embodiments, the image extraction module 66 of the context analysis server 60 obtains digital image data and any associated context data from the image database 62 and extracts image objects from the digital image data and metadata. Available image processing methods may be utilized in accordance with step 301. For example, image recognition software may be utilized by the image extraction module 66 to identify the presence of image objects (identified or unidentified) within a digital image.

At step 302, contextual analysis is performed for each image object to identify each image object and generate object identification data. In aspects, the contextual analysis module 68 performs contextual analysis of photographs, video clips, and surrounding or associated information (e.g., context information such as sound recordings, sensor information, metadata, text, etc.), and recognizes each and every image object based on identified roles, actions and relationships with other image objects. In aspects, the contextual analysis module 68 utilizes stored relationship data in the relationship database 64 in the performance of step 302. In aspects, the object identification data generated at step 302 is saved in the image database 62 and/or the relationship database 64.

In step 303, contextual analysis is performed for each image object to generate usage patterns for the image objects identified in step 302. In embodiments, the contextual analysis module 68 generates usage patterns for each image object utilizing stored relationship data in the relationship database 64. In aspects, usage patterns generated at step 303 are saved in the relationship database 64.

In embodiments, in the performance of step 303, the contextual analysis module 68 creates a usage pattern of various identified image objects from the following gathered content for any specified time frame: all possible objects extracted from photographs or video clips; gathered sensor data from wearable devices (e.g., smartwatch 92); spoken content (e.g., recorded with recording module 84); and contextual analysis of the image object surroundings (i.e., other image objects surrounding the image object of interest).

At step 304, relationship data is generated for each image object identified at step 302. In embodiments, the contextual analysis module 68 clusters the gathered contents from step 303 to find: the relationship of each image object with various sensor parameter values (sensor data); the relationship of each image object with various spoken contents (sound data); the relationship of each image object with each of the other associated image objects; and the relationships of each image object with surrounding context or environment. Correlation methods can be utilized to determine relationships between an identified image object and one or more actions and other objects utilizing relationship data in the relationship database 64.

At step 305, steps 300-304 may be repeated any number of times to build a knowledgebase for the system 50. Thus, embodiments of the invention provide the system 50 with the ability to “learn” over time, enabling the system 50 to recognize and reinforce contextual understanding in a refined way as steps 300-304 are repeated.

At step 306, the context analysis server 60 receives a user query. In embodiments, the context analysis server 60 receives a user query from the user computer device 80 through the network 55. In aspects, the context analysis server 60 receives a user query directly from a user through a user interface (e.g., I/O interface 22) of the context analysis server 60. In embodiments, the user query is in the form of a selection of an image object. In embodiments, the user query is in the form of a question submitted by the user.

At step 307, the context analysis server 60 identifies one or more objects of the query and one or more uses of the object. In embodiments, a user submits a query by selecting an image object at step 306, and the context analysis server 60 identifies the image object (identifies which object is shown) at step 307, and also identifies one or more uses for the object from the relationship data in the relationship database 64. The selected image object may be identified at step 307 utilizing image recognition software and relationship data stored in the relationship database 64. In alternative embodiments, the context analysis server 60 receives a question from a user at step 306, and determines at step 307 an object associated with the question utilizing relationship data stored in the relationship database 64. By way of example, a user may submit a query at step 306: “What can I use instead of an umbrella when it is raining?” In response, the context analysis server 60 may determine that the user is requesting information regarding the action “protecting users from rain”, and utilize relationship data stored in the relationship database 64 to determine one or more objects that are associated with the action “protecting users from rain”.

At step 308, the context analysis server 60 generates a query response based on the one or more objects and uses identified at step 307. In aspects, the query response will be sent to the user computer device 80 through the network 55. In aspects, the query response will be displayed to a user through a display of the context analysis server 60 (e.g., display 24). In embodiments, the query response will include proposed uses for an object. In alternative embodiments, the query response will include proposed objects capable of performing one or more actions. For example, the query response may propose that a user can utilize a clear plastic bag to perform the action “protecting users from rain”.

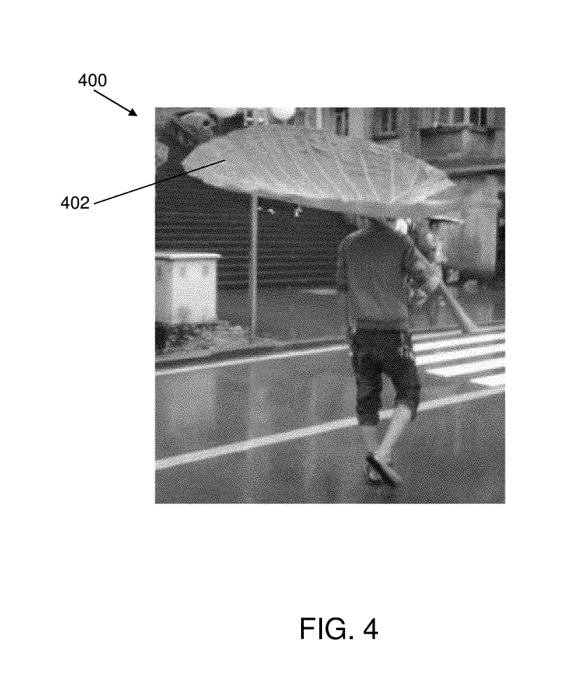

FIG. 4 illustrates an exemplary use case in accordance with aspects of the invention. FIG. 4 depicts a digital image 400 and the exemplary use case is described using elements and steps of FIGS. 2 and 3.

In the following use case, participating devices of the system 50, including user computer devices (e.g., user computer device 80), servers (e.g., context analysis server 60), mobile devices (e.g., mobile device 94) and wearable devices (e.g., smartwatch 92), are connected with others (not shown) and share shareable information with one another, including sensor parameters values and analytics on sensor data. Photographs and video clips captured by one or more of the participating devices in accordance with step 300 of FIG. 3 are shared between eligible devices (e.g., the mobile device 94, the smartwatch 92, the user computer device 80, the context analysis server 60). Software installed in the participating devices (e.g., program instructions of module 42) or on the context analysis server 60 (e.g., program instructions of the image extraction module 66) extract image objects from photographs and video frames shared within the system 50, and also extract metadata (e.g., time of capture, location of capture, etc.) from the frames and photographs in accordance with step 301 of FIG. 3. Software installed in the participating devices (e.g., program instructions of module 42) or on the context analysis server 60 (e.g., program instructions of the image extraction module 66) also identify extracted image objects from the photographs and video frames shared within the system 50 in accordance with step 302 of FIG. 3.

In accordance with step 303 of FIG. 3, the software (e.g., program instructions of the context analysis module 68) performs contextual analysis of photographs and/or video clips shared within the system 50 to create a correlation indicating how any identified object pictured in the photographs and/or video clips are being used in the photographs and/or video clips.

In accordance with step 304 of FIG. 3, the software (e.g., program instructions of the context analysis module 68) also determines similarities with other actions, and determines relationships with other objects within the relationship database 64 to generate relationship data. In furtherance of step 304 of FIG. 3, the software (e.g., program instructions of the context analysis module 68) creates correlations with sensor parameter values or analytical sensor parameter values with identified image objects for any specified time range. While performing contextual analysis, the software gathers available surrounding sound data and environmental parameter data to assist in the identification of actions and objects. Based on the gathered sound and environmental parameter data, the software creates a correlation with the identified objects and with the object's role or action being performed by the object. With respect to the video clips analyzed, the identified object's relationship with sensor parameters is determined, as is the object's relationship with its contextual meaning based on spoken words (sound data) associated with the video clips. All of the data gathered by the system is profiled, and the relationship amongst objects, actions, sensor parameter values, environmental parameters and contextual meaning (based on spoken words) is created (relationship data is generated).

In this scenario and in accordance with step 306 of FIG. 3, a query is received by a participating device (e.g., context analysis server 60), wherein the query is comprised of a user selecting an object 402 depicted in a digital image 400 utilizing a user interface (e.g., display 24) of the user computer device 80.

In this scenario and in accordance with step 307 of FIG. 3, system software (e.g., program instructions of the contextual analysis module 68) identifies all of the possible relationships with objects, actions, etc. stored in the relationship database 64, thereby identifying the image object 402 as a taro leaf and recognizing one or more uses for the taro leaf. For example, the contextual analysis module 68 recognizes that taro leafs can be used to shield a user from rain.

In another exemplary scenario, an image (not shown) is captured in accordance with step 300 of FIG. 3, which depicts a person holding a plastic bag over their heads in a rainstorm, while surrounded by other people utilizing umbrellas. The image extraction module 66 extracts the umbrellas, people, and the plastic bag as image objects in accordance with step 301 of FIG. 3. In accordance with step 302, the contextual analysis module 68 identifies the image objects as umbrellas, people and a plastic bag. In accordance with steps 303 and 304 of FIG. 3, the contextual analysis module 68 recognizes that umbrellas protects people from rain, and that the plastic bag is utilized in the same manner as the umbrellas (i.e., to protect a person from the rain), based on relationship data stored in the relationship database 64. The relationship data generated at step 304 is added to the relationship database 64. Thus, utilizing comparative learning, the context analysis server 60 compares a large plastic bag to an umbrella, and compares the large plastic bag against the activities performed in the same situation. In this scenario, even though the plastic bag is not an umbrella, the system can determine that the plastic bag can be used during rain as an alternative to an umbrella.

In this scenario, it is raining, and a user does not have an umbrella. The user queries the context analysis server 60 in accordance with step 306 of FIG. 3 to obtain other options for performing the same or similar action/function as the absent umbrella. The context analysis server 60 guides the user through various alternative objects that may be utilized, including a plastic bag, and generates a query response for the user in accordance with step 308 of FIG. 3, in which the context analysis server 60 identifies a plastic bag as an object that can be utilized in the absence of an umbrella. In this manner, the system 50 of the present invention is configured to guide a user through various usages of any object, so that a user can perform or execute a required action in the absence of the object.

Optionally, a user query may be presented in the form of a question regarding uses for a particular object in accordance with step 306 of FIG. 3. For example, a user query may present a question regarding uses for a taro leaf, and the system 50 may present the user with a response in accordance with step 307 of FIG. 3, wherein the response lists one or more uses for a taro leaf.

In aspects, software of the system 50 (e.g., contextual analysis module 68) creates a knowledgebase in the form of stored relationship data in the relationship database 64, and the knowledgebase can be refined gradually using data captured and analyzed by the system 50 in accordance with steps 300-304 of FIG. 3, in order to enable the identification of objects and actions in accordance with step 306 of FIG. 3 in a refined way. Thus, embodiments of the invention provide a cognitive object and object use recognition system 50 that builds a corpus of data to provide system “learning” that enables system 50 to recognize and reinforce contextual understanding over time. For example, in the second use scenario discussed above, the first time system 50 processes a picture of a person wearing a plastic bag in the rain, the context analysis server 60 creates an association between the plastic bag and the use of the plastic bag. With enough subsequent occurrences of people utilizing plastic bags in the rain, the system 50 can “learn” not only that plastic bags can be used in the rain, but that the use of plastic bags in the rain is potentially one of the more optimal uses of the object when another object used for the same purpose (e.g., an umbrella) is not available. Thus, use of the system 50 over time improves output of the system 50. In aspects, the system 50 not only guides the user through various alternative objects that may be utilized for a particular purpose, but guides the user through the best known alternative objects, learned by the system 50, that may be utilized.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still another embodiment, the invention provides a computer-implemented method for cognitive object and object use recognition using digital images. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for cognitive object and object use recognition using digital images, comprising:
receiving, by a computing device, a plurality of digital images respectively created by different image capturing devices from different directions;
extracting, by the computing device, image objects depicted in the plurality of digital images and metadata associated with the plurality of digital images;
performing, by the computing device, contextual analysis of each of the image objects and each of adjacent image objects respectively surrounding the image objects, wherein the contextual analysis is based on context data other than image data of the image objects and the adjacent image objects;
generating, by the computing device, relationship data based on the contextual analysis including a relationship between each of the image objects and one or more usages of the image object;
storing, by the computing device, the relationship data in a relationship database; and
identifying the image objects in the digital images based on the image data regarding each of the image objects in the plurality of digital images and the context data regarding each of the image objects and of adjacent image objects respectively surrounding the image objects.

2. The method of claim 1, wherein the step of performing contextual analysis includes:
performing, by the computing device, contextual analysis of each of the image objects to identify each of the image objects; and
performing, by the computing device, contextual analysis of each of the image objects to generate usage patterns for each of the image objects.

3. The method of claim 1, further comprising:
receiving, by the computing device, a user query;
identifying, by the computing device, one or more objects of the user query and one or more uses of the object; and
generating, by the computing device, a response to the query based on the identifying.

4. The method of claim 3, wherein the user query is a query regarding the identity of a select image object, and the response to the query includes information about the select image object.

5. The method of claim 3, wherein the user query is a query regarding potential uses of an object, and the response to the query includes information about potential uses of the object.

6. The method of claim 3, wherein the user query is a query regarding substitutes for a user identified object, and the response to the query includes one or more objects that may be utilized as a substitute for the user identified object.

7. The method of claim 1, further comprising:
receiving context data related to the image objects; and
performing contextual analysis of the context data.

8. The method of claim 7, wherein the context data comprises one or more selected from the group consisting of: sound data, sensor data, metadata, and text data.

9. A computer program product for cognitive object and object use recognition using digital images, the computer program product comprising a computer readable storage medium having program instructions embodied therewith, the program instructions executable by a computing device to cause the computing device to:
receive a plurality of digital images, respectively created by different image capturing devices at different times, and context data associated with the plurality of digital images;
extract image objects depicted in the plurality of digital images and metadata associated with the plurality of digital images;
perform contextual analysis of each of the image objects and each of adjacent image objects respectively surrounding the image objects, wherein the contextual analysis is based on image data and context data other than image data of the image objects and the adjacent image objects;
generate relationship data based on the contextual analysis including a relationship between each of the image objects and one or more usages of the image object, and
identify the image objects in the digital images based on image data regarding each of the image objects in the plurality of digital images and context data regarding each of the image objects and of adjacent image objects respectively surrounding the image objects.

10. The computer program product of claim 9, wherein the program instructions further cause the computing device to perform the contextual analysis by causing the computing device to:
perform contextual analysis of each of the image objects to identify each of the image objects; and
perform contextual analysis of each of the image objects to generate usage patterns for each of the image objects.

11. The computer program product of claim 9, wherein the program instructions further cause the computing device to:
receive a user query;
identify one or more objects of the user query and one or more uses of the object; and
generate a response to the query based on the identifying.

12. The computer program product of claim 11, wherein the user query is a query regarding the identity of a select image object, and the response to the query includes information about the select image object.

13. The computer program product of claim 11, wherein the user query is a query regarding potential uses of an object, and the response to the query includes information about potential uses of the object.

14. The computer program product of claim 11, wherein the user query is a query regarding substitutes for a user identified object, and the response to the query includes one or more objects that may be utilized as a substitute for the user identified object.

15. The computer program product of claim 9, wherein the context data comprises one or more selected from the group consisting of: sound data, sensor data, metadata, and text data.

16. A system for cognitive object and object use recognition using digital images, comprising:
a CPU, a computer readable memory and a computer readable storage medium associated with a computing device;
program instructions to receive a plurality of digital images, respectively created by different image capturing devices from different directions and at different times, and context data associated with the plurality of digital images;
program instructions to extract image objects depicted in the plurality of digital images associated with the plurality of digital images;
program instructions to perform contextual analysis of each of the image objects and each of adjacent image objects respectively surrounding the image objects and the context data,. wherein the contextual analysis is based on image data and context data other than image data of the image objects and the adjacent image objects;
program instructions to generate relationship data based on the contextual analysis, including a relationship between each of the image objects and one or more usages of the image object;
program instructions to receive a user query;
program instructions to identify one or more objects of the user query and one or more uses of the object, wherein the identifying comprises identifying the image objects in the digital images based on the image data regarding each of the image objects in the plurality of digital images and the context data regarding each of the image objects and of adjacent image objects respectively surrounding the image objects; and
program instructions to generate a response to the query based on the identifying, wherein the program instructions are stored on the computer readable storage medium for execution by the CPU via the computer readable memory.

17. The system of claim 16, wherein the program instructions to perform contextual analysis include:
program instructions to perform contextual analysis of each of the image objects to identify each of the image objects; and
program instructions to perform contextual analysis of each of the image objects to generate usage patterns for each of the image objects.

18. The system of claim 16, wherein the user query comprises one or more of the group consisting of: a query regarding the identity of a select image object; a query regarding potential uses of an object; and a query regarding possible substitutes for a user identified object.

19. The system of claim 18, wherein the query is a query regarding the identity of the one or more objects, and the response to the query includes information about the one or more objects.

20. The system of claim 16, wherein the context data comprises one or more selected from the group consisting of: sound data, sensor data, metadata, and text data.
